(19) United States
(12) Patent Application Publication
(10) Pub. No.: US 2006/0140502 A1
(43) Pub. Date: Jun. 29, 2006

(54) Active visor system for eliminating glare in field-of-vision from mobile and transient light sources and reflective surfaces

(75) Inventors: Allan S. Tseng, Chelmsford, MA (US); Prateek S. Aggarwal, Melrose, MA (US)

Correspondence Address: PRATEEK S AGGARWAL, PH.D., 30 TAPPEN STREET, #2, MELROSE, MA, 02176, US

(73) Assignees: Allan S. Tseng, Chelmsford, MA (US); Prateek S. Aggarwal, Melrose, MA (US)

(21) Appl. No.: 10/905,296

(22) Filed: Dec. 25, 2004

(51) Int. Cl. G06K 9/40

(52) U.S. Cl. 382/275

(57) ABSTRACT

A field-of-vision processing and filtering system for eliminating glare from mobile and transient light sources and reflective surfaces, using image recording, eye-position detection, and a active matrix screen functioning as a dynamically controllable visor, for modifying the field of vision appropriately. The system filters out high light intensity points from the field of vision, without seriously affecting the relevant parts of the field of vision. One embodiment of the system can be used by drivers for filtering glare from oncoming headlight at night, as well as during day time to block glare from the sun. Another embodiment of the system can be used for protection from glare of welding iron in a machine shop.

### BACKGROUND OF THE INVENTION

A product that will automatically minimize severe oncoming glare from mobile light sources and reflective surfaces using an active and transparent LCD screen acting as a dynamically controllable visor. The glare could be caused by the incidence of headlights from oncoming vehicles on the drivers' eyes during night, or from sunlight during day, sometimes causing temporary blindness. The goal of this technology is to selectively minimize the intensity of the incident light resulting in glare, by using a transparent surface with the capability of selectively controlling its transparency at specific locations on the surface. Since the glare location on such a surface is mobile, multivariate adaptive algorithms have to be applied to correctly identify the location of glare within the field of vision.

### SUMMARY OF THE INVENTION

We deal with sunlight brightness in a respect in two fashions, one a complete block with a visor and a partial block/filter, sunglasses. We have learned how to use visors that virtually block all light/information. They work well for our use; yet require a learned behavior because they are a complete block. We do not use this at night because of the fact that there is not enough peripheral light energy covering other areas to aid in navigation. We also use sunglasses during the day to combat sunlight, yet we have also found that putting them on at night is also not practical because we lose all or too much information. To date as a headlight comes directly at us we tend to shut out everything and even migrate directly at the source in some cases.

Another type of headlight glare that causes drivers a problem is car headlights coming from the rear, this light comes into the rearview mirror and is reflected to the driver. There are many patents that address this problem. Uses of mirrors with contrasting displays have been utilized in art like U.S. Pat. No. 4,443,057 to Bauer which is incorporated herein by reference. Like U.S. Pat. No. 6,247,820 to VanOrder, which is incorporated herein by reference Like U.S. Pat. No. 6,299,316 to Fletcher which is incorporated herein by reference. These and many of the others employ active methods. These are very effective at their purpose of reducing the light from behind, where the amount of data here is not critical. Where a reduction in total energy making it to the driver is acceptable and a good product. We typically just need to know if a car is far or close to us at night. Whereas we do not want to decrease our vision data in front of us. Oncoming headlights can prevent us from being able to see in the direction the car is moving, which the more data/input our brain has the better our driving ability will be.

There are several patents that are trying to deal with oncoming headlight glare (OHG). Some try to filter with sunglass technology in certain regions of the windshield which reduces the total information coming back to the driver, Like U.S. Pat. No. 6,056,397 to Berlad which is incorporated herein by reference. This is a passive solution that filters the light all the time. This has problems like, various height persons and no matter what it does reduce the total amount of data/energy from the drivers own headlights that make it back to the driver.

Attempts at stopping OHG have included polarizers, another passive method, like U.S. Pat. No. 6,208,463 to Hansen which is incorporated herein by reference; Like U.S. Pat. No. 6,299,231 to Reitz which is incorporated herein by reference. This again reduces the total amount of light energy that reaches the drivers eyes.

Adaptive headlights automate the brightness of high beams Like U.S. Pat. No. 6,144,158 to Beam which is incorporated herein by reference, that do not reduce the OHG by normal headlights, just decrease the drivers headlights from being on high beam. Like U.S. Pat. No. 6,049,171 to Stam which is incorporated herein by reference also just reduces the driver's ability to blind the other drivers with his bright lights on.

Like U.S. Pat. No. 6,056,424 to DiNunzio which is incorporated herein by reference addresses glare reduction by putting a light source inside the car to reduce the dilated pupil. This in effect may mitigate severe blindness as the oncoming car approaches but it will on an average decrease the total amount of information the brain receives to make decisions from the outside of the vehicle due to the smaller dilation of the eye.

Popular technologies/products that use the time shutter principle are motion pictures, cameras, TV's, and so on. Shuttering principles have been used for years in conjunction with external energy flashes; they are used in consumer cameras for years known as flash, and are typically one time flashes. Like U.S. Pat. No. 3,952,253 to Dr. Alexander DeVolpi which is incorporated herein by reference also uses a strobing neon light source to match the shuttering camera (high-speed framing camera) “seeing/recording” time as a continuous strobe recording at very high speeds for Nuclear Reactors.

Glasses that use shuttering principles are Like U.S. Pat. No. 5,478,239 to Fuerst which is incorporated herein by reference uses LCD glasses that shutter clear and block light to allow athletes to train with limited optical input to increase the user's real life proficiencies. Like U.S. Pat. No. 4,201,450 to Trapani which is incorporated herein by reference uses an electro-optic shield to limit the amount of light to the wearer's eyes, he used glasses, helmets, goggles welding plates and so on. Like U.S. Pat. No. 5,015,086 to Okaue which is incorporated herein by reference used LCD glasses to block the sun and have a switch to have two levels.

### DESCRIPTION OF THE PREFERRED EMBODIMENT

In principle the Active Visor Glare Reduction System is very simple, since it involves filtering the high-intensity glare emitting light source from the field of vision of the observer. We put an active shield in front of the driver. The shield is capable of allowing light energy to pass through it and is also able, with a control signal, to prevent light or severely restrict light energy from passing through at specific locations in the shield.

In one embodiment of the Active Visor Glare Elimination system (shown in FIG. 1), we use the image recorded from a camera 1 placed on the eye-piece of the subject to capture his field-of-vision, and to evaluate the specific locations within his field-of-vision 4, on the visor 3, that need to be blocked. For this embodiment, we need to compute the position of the light source adaptively, using the microcontroller 2 that send a position-specific light attenuation signal to the visor. To achieve this, we strobe the location-specific blocking in the field of vision, for multiplexing between the light source and the filtered image. The strobe is synchronized with the camera shutter, so that the filtered and unfiltered images are captured by the camera at the maximum possible contrast. The shuttering speed of the camera is selected so that the adaptation speed is effective for selectively filtering glare in any given location in the field of vision.

In another embodiment of the Active Visor Glare Elimination system, we use the image recorded from four cameras placed on the active visor 10,6, two 6 to capture the driver's field-of-vision 9, and the other two 10 to monitor the eye-position of the driver. Triangulation of the images from each of the camera pairs indicates exact position of the eye and glare source 9, relative to the visor. This position information is used to evaluate the specific locations within his field-of-vision, on the visor 8, that need to be blocked. For this embodiment, we need to compute the position of the light source adaptively using the microcontroller 7, while continuously recording from the cameras. For this embodiment, the driver is not restricted in any manner because he is not required to handle or wear any apparatus.

Following is a description of the primary components of the system (as shown in FIG. 3). The system consists of an active matrix light filter panel 16, an image capture system consisting of one or more cameras 15, a visor position detection system 14 which may or may not be incorporated within the computer-based microcontroller system. The microcontroller system 18 receives input from the eye position detector 12, head tilt sensor 11, visor position detector 14, and image capture system 15, and uses these inputs to adaptively calculate the exact position of glare-producing light sources on the active visor shield. A strobe mechanism 13 is used to strobe between filtered and unfiltered images for the image capture system.

Eye Position Detector

The eye position detector 12 measures the eyes' position relative to the Light Filter Panel. This sensor will be based on a camera and uses infrared light as light source to illuminate the pupils. Software can then calculate the position of the illuminated eyes. The relative position of the two eyes can be used to calculate the head tilt also.

Tilt Sensor

A head tilt sensor 11 may be placed in an eyepiece worn by the subject, so that the exact angle of the head relative to the panel can be computed. This data can also be used to confirm the information recorded from the eye position detector. The tilt sensor is an optional component of the different embodiments of the Glare Elimination system.

Active Matrix Light Filter Panel

This panel 16 is similar to Active Matrix LCD panel used in computer monitor. This panel is specially designed so that it provides pixel-by-pixel control over transparency of different locations on the panel, using individual transistors for each pixel. The light-blocking filter can be turned on individually at any location on the panel. The active matrix screen is transmissive, allowing unrestricted view of the driver's field of vision. The capacity to selectively turn off the transmissivity for each pixel, by the Glare Elimination system micro-controller, enables the glare elimination capability of the Glare Elimination system.

Image Capture System

The image capture system 15 could be mounted on the visor, or could be mounted on the eyepiece worn by the subject. The system could be one or more small CCD cameras 1,6 with their output connected to the computer based microcontroller. The output could be fed to a separate visor position detector 14, depending upon the embodiment of the microcontroller. If the embodiment of the microcontroller has an inbuilt active visor position detector, then the separate output may not be necessary.

Active Visor Position Detector

The active visor position detector 14 consists of a pair of infra-red LEDs placed on the visor, and a device/algorithm for computing the positions of the IR LEDs using the output of the image capture system. This component of the invention is only required for the first embodiment of the Glare Elimination system.

Synchronized Shutter System for Recording Filtered and Unfiltered Images Simultaneously

The output of the microcontroller is fed to a shuttering system 13 which could be either a software module or a separate hardware component. The output of the shuttering system is fed into the active matrix screen 16, as well as the recording camera 15. The synchronizing clock at the output of the shuttering system is used (1) by the camera to determine exact time to capture the image, and (2) by the active matrix screen, to determine the exact time for being completely transmissive. Thus, the shuttering system is be used to provide access to both filtered and unfiltered images to the microcontroller. Using both the images, the glare filtering by the microcontroller would be much more adaptive and accurate. The synchronized shutter system is only used in the first embodiment of the Glare Elimination system.

Glare Intensity and Position Detection Software

The Glare Elimination system works on the principles of (1) identifying relative positions and intensities of light sources generating glare from the image captured by the Image Capture System mentioned above (2) using the eye position detected with the Eye position detector to compute the exact location of the glare sources on the active matrix light filter panel. Achieving the objectives of glare location detection on visor requires two sets of computational algorithms.

Glare Intensity and Position Calculation Relative to Image Capture System

Given the image recorded from one or more cameras of the image capture system, image processing algorithms are used (such as image smoothing, edge detection, intensity thresholding etc.) to determine the number of high intensity light sources in the field of vision of the driver, and the exact intensity and position of each of the light source. For the first embodiment containing only one eyepiece camera, this algorithm is simpler than the second embodiment, where different glare sources identified for each of the multiple cameras need to be matched with other such glare source on other cameras.

Glare Position Calculation Relative to the Active Matrix Panel

Once the position and intensity of different glare sources on each of the image capture system cameras has been identified, a second set of nonlinear adaptive algorithms (e.g., geometric triangulation, light source diameter calculation, adaptive prediction of light source trajectory etc.) is used to determine the exact pixel position on the active matrix filter, that needs to used for attenuating glare. The path of light can be calculated by using the high intensity light source location and position of the operator's eyes from the CCD sensors. The Light Filter Panel is positioned so that its intercepts the light paths before it reach the eyes. If the intensity of the light is over the set threshold the Light Filter Panel can attenuate it before it reaches to the eyes. For the first embodiment, these algorithms would be simpler than the second embodiment, given that information from multiple images needs to be integrated for the second embodiment. Also, the algorithms in the second embodiment depend upon the proper calibration of the location of the cameras relative to the visor, while all the information regarding relative position is embedded within a single image in the first embodiment.

Recharging System for a Completely Autonomous System

The Glare Elimination System has been designed for use by drivers in automobiles. An essential property of this system is that it is fully portable. Since it consists of active components, recharging these active components is required for portability. More specifically, for the first embodiment, the camera in the eyepiece is charged on an offline basis when not being used. Wireless image transmission from the camera to the glare elimination system within the automobile also requires a short-range wireless transmitter embedded within the eyepiece. A recharging system accompanies the Glare elimination system for charging these different active components.

### BRIEF DESCRIPTION OF THE DRAWINGS

FIG. 1 First Embodiment of the Glare Elimination System using a single camera on the eyepiece and an active visor controlled with a microcontroller

FIG. 2 Second Embodiment of the Glare Elimination System using a set of multiple cameras embedded within the active visor

FIG. 3 Block diagram of the Glare Elimination System.

### DESCRIPTION OF THE DRAWINGS

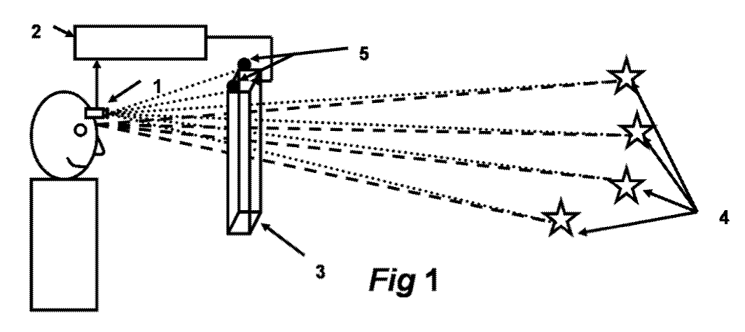

In FIG. 1 we have camera 1 recording the glare sources 4 in the field of vision of the driver filtered through the active visor 3. The recorded image is used by the microcontroller 2 to control the transparency of the active visor at specific points in the field of vision, based on the position of the visor computed using LED inputs 5.

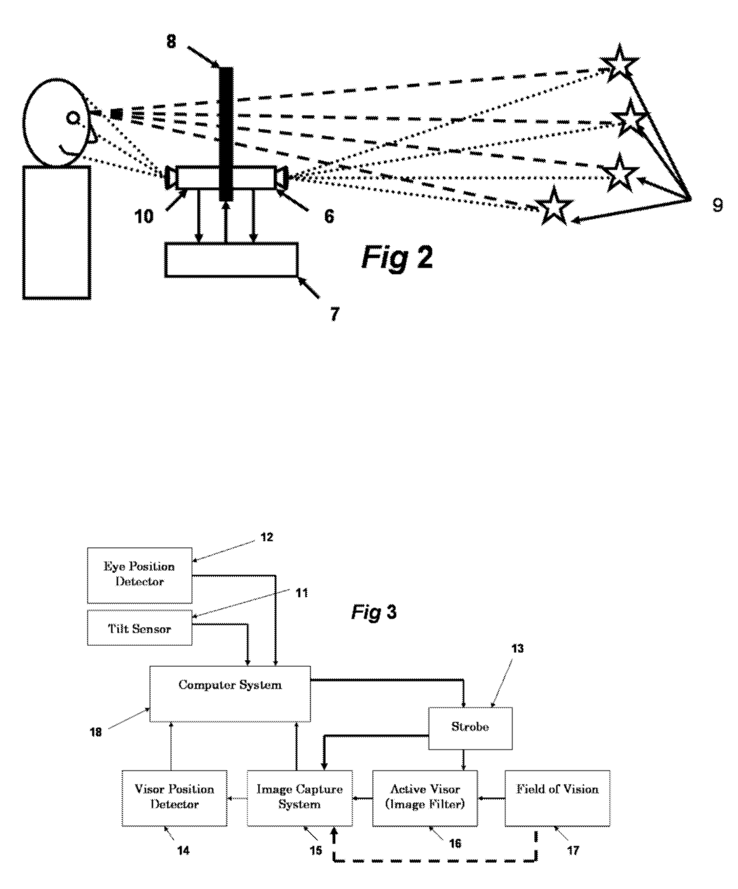

In FIG. 2 Camera 10 and 6 record the driver's eye-position and the glare sources 9 in the field of vision, respectively. Images recorded by the cameras are fed to a microcontroller 7 that controls the transparency of the active visor 8.

In FIG. 3 we have the block diagram of the active visor glare elimination system. The computer system 18 receives inputs from visor position detector 14, image capture system 15, the eye position detector 12, and the tilt sensor 11. Output of the computer system feeds into the strobe 13, which in turn controls the Image capture system and the active visor (image filter) 16. The active visor, thus, filters the field of vision 17 of the driver.

What is claimed is:

1. A glare elimination system that has a means of generating a control signal for controlling an Active matrix light filter panel.

2. An active visor functioning as light filter panel with functionality for selectively lowering the light intensity at specific pixels in the image.

3. A glare elimination device as in claim 1 with an adaptive glare position tracker using multivariate nonlinear adaptive algorithms for calculating location of pixel on visor as in claim 2 corresponding to glare, given glare source and eye position.

4. In one embodiment, a glare elimination device as in claim 1 with input from a camera embedded in the active visor as in claim 2 for capturing the image viewed by the observer.

5. The second embodiment of a glare elimination device as defined in claim 4, which has input from an eye position sensor device embedded in the active visor as in claim 2 for calculating the orientation of the observer's eyes relative to the visor.

6. The first embodiment of glare elimination device as defined in claim 4, with an optional input from a tilt sensor to determine the head orientation relative to visor.

7. A second embodiment of the g/are elimination device as defined in claim 2 that has input from cameras embedded in the active visor for capturing the image viewed by the observer.

8. A glare elimination device as defined in claim 4 with input from light-emitting diodes placed on the visor for detecting the position of the visor from the camera on the eyepiece.

9. A glare elimination device as in claim 4 with a shuttering of glare-free and original fields of vision.

10. A glare elimination device as in claim 4 with a recharging cradle for charging the active components in the system such as the stand-alone wireless camera as in claim 7.
